(19) United States
(12) Patent Application Publication
(10) Pub. No.: US 2011/0279478 A1
(43) Pub. Date: Nov. 17, 2011

(54) Virtual Tagging Method and System

(76) Inventor: Lokesh Bitra, Villeneuve- Loubet (FR)

(21) Appl. No.: 13/124,397

(22) PCT Filed: Oct. 23, 2009
(86) PCT No.: PCT/EP2009/007605

§ 371 Date: Jul. 7, 2011

(30) Foreign Application Priority Data
Oct. 23, 2008 (EP) 08018596.0

(51) Int. Cl. G09G 5/00

(52) U.S. Cl. 345/633

(57) ABSTRACT

A method for associating a virtual tag with a geographical location, comprising the steps of displaying (210) a two-dimensional geographical map; receiving (220) inputs specifying a line on the map; displaying (230) a vertical plane passing through the line, perpendicular to the map; receiving (240) information specifying a position of a virtual tag on the displayed vertical plane; and storing (250) the name and position of the virtual tag and the coordinates of the line on the map in a database.

The present invention relates to a hand-held augmented reality (AR) system and method wherein a live direct or indirect view of a physical real-world environment is merged with or augmented by virtual computer-generated imagery in real time and/or in real location, or in a remote desktop in a simulated or virtual environment.

### TECHNICAL BACKGROUND AND PRIOR ART

Today, many portable or hand-held communication devices are equipped with geographical position sensors and provide access to the Internet. Location awareness is generally seen as a key for many next generation services. However, access and interaction with location sensitive information are so far limited to text- or map-based interfaces. Although these interfaces provide hyperlinks, they are still very removed from the way humans naturally act when referring to a geographical location, namely by just looking or pointing at it.

US 2006/0164382 A1 discloses a mobile phone device comprising a screen display. A user of the device is able to vertically or horizontally move an image within the display screen by moving or positioning the device in space. The device includes a position sensor for sensing movement of the device's display screen relative to another object. The image can also be zoomed in or out by bringing the device display screen closer to or farther from the user.

US 2007/0035561 A1 (Bachelder et al.) relates to a system for combining virtual and real-time environments. The system combines captured real-time video data and real-time three-dimensional environment rendering to create a fused (combined) environment. The system captures video imagery and processes it to determine which area should be made transparent of have other color modifications made, based on sensed features and/or a sensor line of sight.

However, the acquired images may not be overlaid with additional information items, such as virtual tags.

It is therefore an object of the present invention to provide a method and a system for augmenting a real-world image with virtual placeholders. It is another object of the invention to provide a method and a system for setting up such placeholders, in an easy and accessible way.

### SUMMARY OF THE INVENTION

These objects are achieved by a method and a system according to the independent claims. Advantageous embodiments are defined in the dependent claims.

In essence, the invention provides technical means enabling a user to access information resources through annotated geospatial visual links/virtual tags that are overlaid over natural images acquired by a handheld device. An augmented reality layer overlaid over a digital image acquired by e.g. a mobile phone camera shows virtual tags in real-time. Virtual tags are interactive vector graphics, i.e. visual markers or graphical representations that can be associated with various functions or linked to a variety of multimedia content. A user equipped with a GPS- and Internet-enabled camera phone may set up, view or edit a virtual tag.

To view existing tags, the user initiates the application and points the camera. All tags in the field of view will be presented automatically as a highlighted outline of a user created form/shape. As the user focuses on any tag, basic information may be presented in a fashion similar to a tooltip in a desktop interface. And when the user clicks on the tag, i.e. presses the assigned button as the tag is in focus, an assigned action may take place, for example loading a website or presenting more information or loading an image.

More particularly, a method for displaying an acquired real-world image augmented with virtual tags may be implemented on a hand-held virtual tagging device having geographic positioning means, digital image acquisition means, data retrieval means and display means and may comprise the steps of obtaining a geographic position of the device; acquiring a digital image; retrieving data from a computer-readable memory, based on the geographical position of the device; augmenting the acquired image by superimposing one or several virtual tags on the image, using the retrieved data; and displaying the augmented image.

This makes it easy and intuitive to find or get information just by clicking on a highlighted virtual tag on the display.

The method may further comprise the step of displaying a tool-tip when a displayed virtual tag receives focus. Also, the method may comprise the step of displaying additional information when the user clicks on a virtual tag. Clicking on a tag may occur when the tag has focus and the user actions a button of the handheld device.

According to another embodiment, the method may further comprise the step of toggling the image between a map-view and a camera-view, depending on the angle of the display. An angle of the display may be determined based on the acquired image. Alternatively, the angle of the display may be determined using angle sensor means comprised within a virtual tagging device.

In a further embodiment of the invention, the geographic position may be used for dynamically positioning the one or several virtual tags in the field of view on the acquired image.

The invention also comprises a computer-implemented method for associating a virtual tag with a geographical location, comprising the steps of displaying a two-dimensional geographical map; receiving inputs specifying coordinates of a line on the map; displaying a vertical plane passing through the line, perpendicular to the map; receiving information specifying a position of a virtual tag on the displayed vertical plane; and storing the virtual tag and the coordinates of the line on the map in a database. Optionally, the method may further comprise the step of specifying the shape of the virtual tag. It may also comprise assigning a name, a message or image or a link to a website for the tag. Moreover, the inputs specifying a line on the map may be received via a gesture-based interface of the hand-held device, e.g. by swiping a finger over a touch-sensitive display.

Finally, the invention also comprises a virtual tagging device, adapted to execute the above-described methods. The tagging device may be a handheld device. According to one embodiment of the invention, it may be a mobile phone.

The systems and methods according to the present invention let users set up virtual tags like “placeholders”, overlaid over real-world images, providing an intuitive and experience-rich medium for location based information seekers and location sensitive service providers. The present invention also allows anyone with a GPS enabled camera phone to set up a virtual tag.

More particularly, the inventive method introduce an easy reference to locations of points in three-dimensional space in the real-world. A dynamic real time three-dimensional geometry obtained from 3D coordinates is made available for mobile phone users and developers. These points/coordinates may be used as a framework for building augmented reality based application; the simple user-interface enables even non-technical mobile phone users to intuitively place/build virtual objects with respect to their location or a given reference.

### DETAILED DESCRIPTION OF A PREFERRED EMBODIMENT

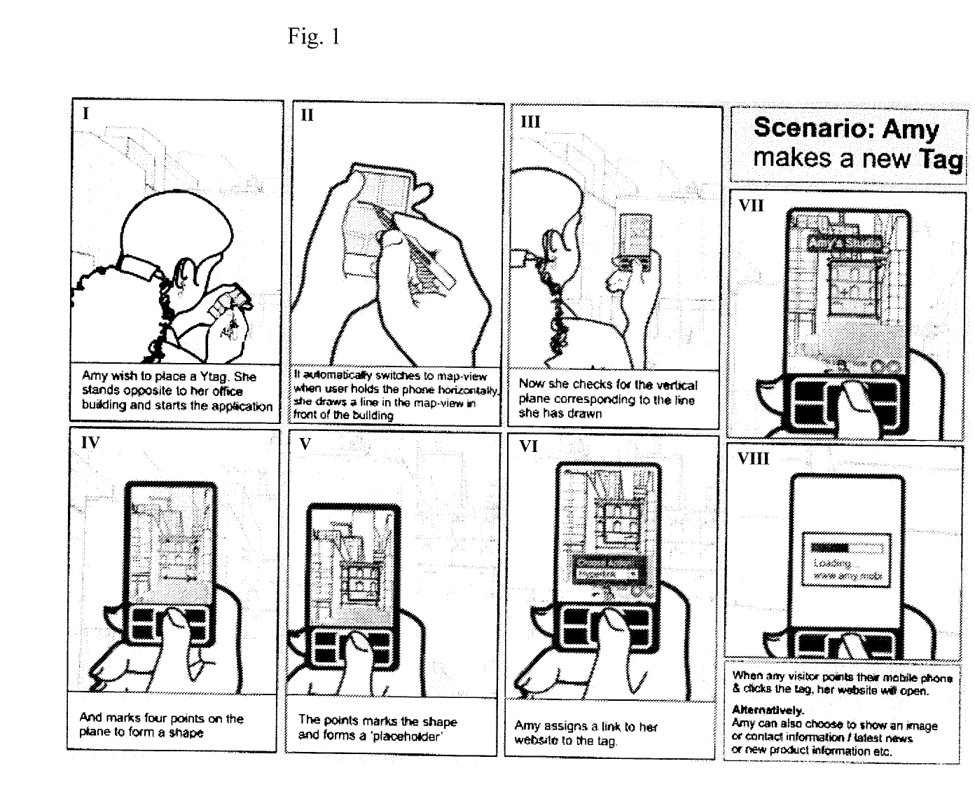

FIG. 1 shows a usage scenario of a preferred embodiment of the inventive methods and system. The first scenario picture I in the upper left corner shows a user standing opposite of a physical building and wishing to place a virtual tag (“Ytag” or “YT”). In the next picture II, the hand-held device running a method according to the invention automatically switches to map-view when the user holds the phone horizontally. The user may then draw a line in the map-view in front of the building. Holding the phone then vertically in picture III, the user may then check whether a vertical plane drawn by the inventive application corresponds to the line the user has specified. Then, in picture IV, the user marks four points on the plane to form a shape. Shapes may be of any complexity and may also be specified by a user's gestures, using e.g. a touch-sensitive display. In picture V, it is shown how the points mark the shape of a virtual tag, forming a ‘placeholder’ for additional information. In picture VI, the user specifies a hyperlink to her website as additional information associated with the virtual tag. Alternatively, she may also choose to show an image or contact information, latest new or product information, etc.

When a visitor points his own mobile phone to the office building, the inventive methods and system will display the tag set previously set up by the user as shown in picture VII, When the user then clicks on the tag, the website to which the associated hyperlink points will open, as shown in picture VIII.

The technical means for implementing such a scenario shall be explained in the following:

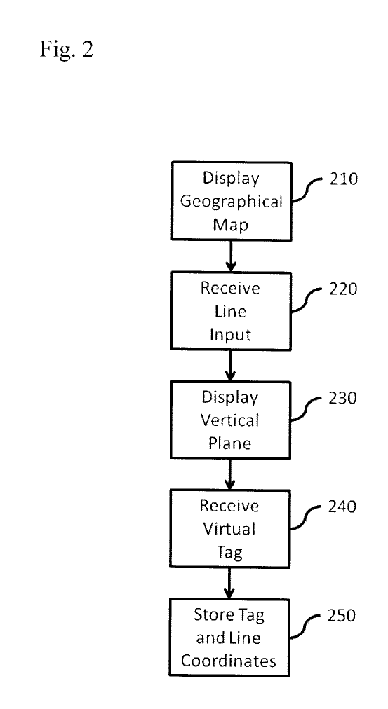

FIG. 2 shows a flow chart of a method for associating a virtual tag with a geographical location and an acquired digital image according to one embodiment of the invention.

In step 210, a two dimensional geographical map is displayed.

In step 220, inputs specifying a line on the map are received. Preferrably, the inputs are given by finger gestures applied to a touch-sensitive display, e.g. by swiping a finger along a line, or by designating two different points, through which a straight line passes.

In step 230, a vertical plane passing through the line, perpendicular to the map is displayed. In doing so, the virtual tagging device displayed may switch from a two dimensional to a three dimensional view. The vertical plane may be transparent, such that an image presently received by a camera is visible and the vertical plane appears overlaid over that image.

In step 240, information is received specifying a position of a virtual tag on the displayed vertical plane. Optionally, the device may further receive a name for the tag and meta data for the tag. Also, a message or an image or a link to a website may be assigned to the tag.

In step 250, the position and name of the virtual tag and associated location information may be stored in a database. More particularly, the associated location information comprises coordinates of the vertical line on the map, thereby associating the virtual tag with a geographical location, as represented on the map. The optionally received information that is also associated with the tag, like the name or a hyperlink, may also be stored in the database.

As new tags are created and stored in the database, the application server may automatically re-calculate and re-build the relationships of each tag with neighboring tags, thereby rendering the overall data set more robust and precise. In other words, the system learns automatically and becomes more accurate. This may in turn improve the performance of the data retrieval mechanism.

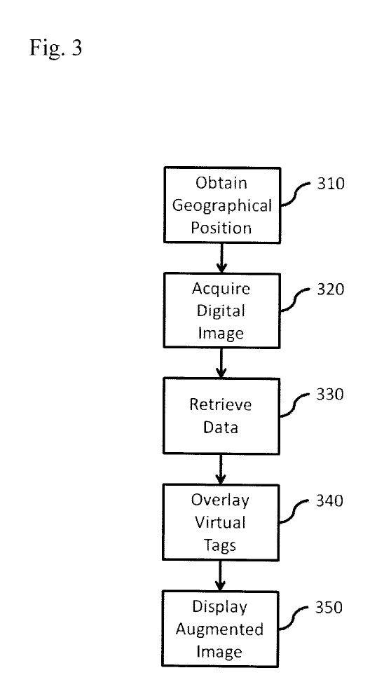

FIG. 3 shows a flow chart of a method for displaying an acquired real-world image augmented with virtual tags according to a preferred embodiment of the invention.

In step 310, a real-world image is acquired by a digital image acquisition means of the virtual tagging device.

In step 320, the virtual tagging device further obtains its geographical position, comprising the latitude, the longitude and the altitude of the device. It may be determined using either a network based or handset based position method, or a mixture of the two. Examples of network bases methods are the SS7 and mobile positioning method, the angle of arrival method, the time of arrival method and radio propagation techniques. Examples of handset based positioning methods are based on a SIM toolkit Enhanced Observed Time Difference (EOTD) or GPS.

Preferrably, a GPS module is responsible for determining the geographical position. Taking into account that present GPS receivers offer only 20 meter accuracy, the hand held system may use GPS techniques, such as WAAS or EGNOS in order to increase the accuracy of the GPS receiver.

In step 330, data associated with the obtained real-world image is retrieved from a computer-readable memory or database. The retrieval may be based on the geographical position of the device. More specifically, data may be retrieved for a given geographical position and a predetermined radius. The orientation (attitude) of the handheld device may be used for filtering the data. Optionally, the acquired real-world image may also be used in data retrieval.

In step 340, the acquired image is augmented by virtual tags. The virtual tags are superimposed on the image, using the retrieved data.

In step 350, the augmented image is displayed.

More specifically, a virtual 3D matrix (AR layer) may be built for a given radius, the geographical position of the device defining the center of the matrix. The virtual tags are positioned in this matrix and presented or displayed according to the perspective.

Whenever there is any change in the orientation (attitude) of the handheld device, the 3D matrix may be rotated in real-time accordingly. As compared to searching around in a two-dimensional map representation of a user's current location, this real-time rotation allows the user of the inventive device to “look around” by panning the handheld device accordingly.

In an optional step 360 (not shown), a tool-tip may be displayed, when a displayed virtual tag receives focus.

In another optional step 370 (not shown), previously stored and retrieved additional information may be displayed, when the user has clicked on a virtual tag.

In another embodiment, the method may further comprise the step of toggling the image between a map-view and a camera-view, depending on the angle of the display. An angle of the display may be determined based on the acquired image. Alternatively, the angle of the display may be determined using angle sensor means comprised within a virtual tagging device.

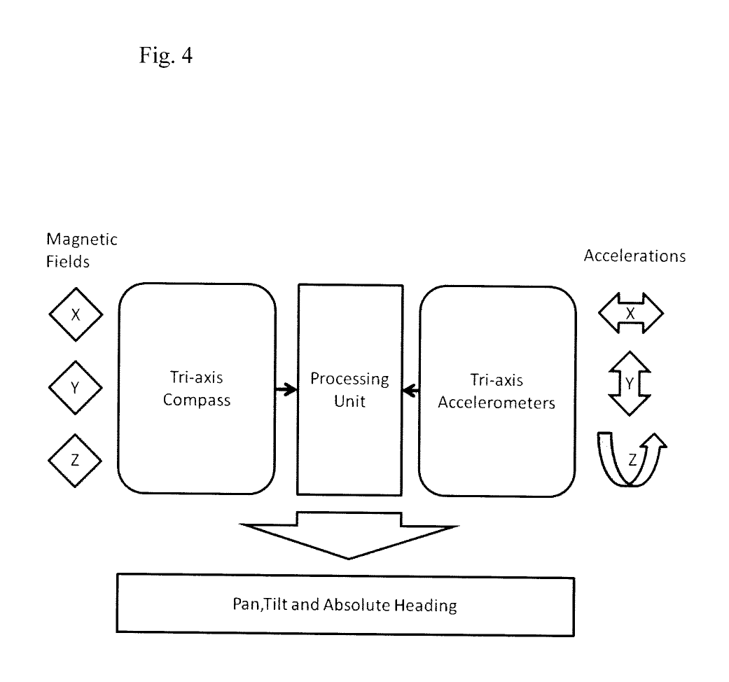

FIG. 4 shows, how according to one embodiment of the invention, the handheld device's orientation may be determined by coupling a three-axis compass and a three-axis accelerometer. This solution offers a good accuracy on rotation/panning (about one degree). More particularly, it can provide three-dimensional absolute magnetic field measurement with full 360 degrees (pitch and roll compensated).

In a spherical coordinate system, as it is used by GPS receivers and geospatial systems, the orientation or angular position (attitude in space of an axis) of an object may be defined by the angles it forms with the axis of a reference frame of the same coordinate system.

A three-axis compass may be used for determining the X, Y and Z magnetic field strengths. The three axis digital compass uses perpendicularly oriented magnetic field sensors and the field strength are converted to voltages and summed to form a composite field strength voltage. The slope polarity and amplitude of the composite field strength voltage may be used to determine the heading of the device where the compass is attached.

Optionally, the digital compass may be calibrated before use. A particular calibration is only valid for that location of the compass. It is also possible to use a compass without any calibration if the need is only for repeatability and not accuracy.

Alternatively, the GPS receivers may also act as a kind of compass by providing the direction of travel (bearing). Bearing is calculated from two distinct positions. Bearing accuracy depends on the GPS receiving conditions (signal quality). The solution may be used for mobile hand held devices that don't have a built-in compass.

A dual axis compass (X, Y) may provide accurate bearing only when held completely flat.

The system further comprises three-axis accelerometers used for measuring X, Y and Z accelerations. By arranging three accelerometers in three orthogonal axes, acceleration measurement from gravity can be estimated for each axis.

The position/orientation may be fixed using the compass and the accelerometer may be used for the variations or movements in all axes, as the accelerometer is more precise and faster than the compass.

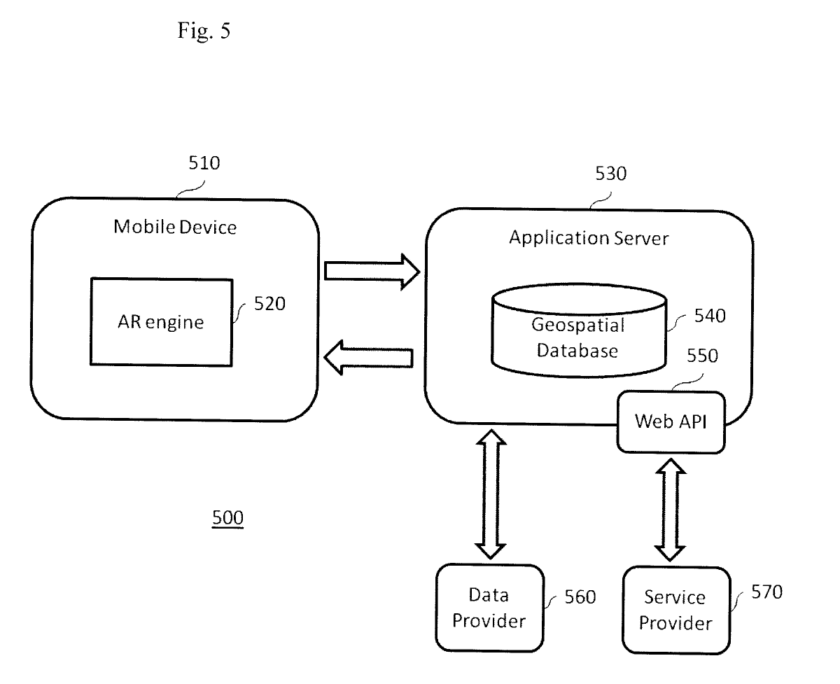

FIG. 5 shows a block diagram of a virtual tagging system 500 according to the invention. The virtual tagging system 500 comprises a mobile device 510, the mobile device 110 comprising an augmented reality engine for data presentation 520. The mobile device communicates with an application server 530 for storing acquired data and for selecting stored data. For that purpose, the application server 530 comprises a geospatial database 540. Third party applications may connect to the application server using a web API 550 for interoperability purposes. Third parties may for example be data providers 560 or service providers 570.

1. Method, implemented on a hand-held virtual tagging device having geographic positioning means, digital image acquisition means, data retrieval means and display means, comprising the steps:
obtaining (310) a geographical position of the device;
acquiring (320) a digital image;
retrieving (330) data from a computer-readable memory, based on the geographical position of the device;
augmenting (340) the acquired image by superimposing one or several virtual tags on the image, using the retrieved data; and
displaying (350) the augmented image.

2. Method according to claim 1, further comprising the step of displaying a tool-tip when a displayed virtual tag receives focus.

3. Method according to claim 1, further comprising the step of displaying further information when the user clicks on a virtual tag.

4. Method according to claim 1, further comprising the step of
toggling the image between a map-view and a camera-view, depending on the angle of the display.

5. Method according to claim 4, wherein an angle of the display is determined based on the acquired image.

6. Method according to claim 1, implemented on a virtual tagging device, wherein the geographic position is used for dynamically positioning the one or several virtual tags on the acquired image.

7. Method for associating a virtual tag with a geographical location, comprising the steps
Displaying (210) a two-dimensional geographical map;
receiving (220) inputs specifying a line on the map;
displaying (230) a vertical plane passing through the line, perpendicular to the map;
receiving (240) information specifying a position of a virtual tag on the displayed vertical plane;
storing (250) the name and position of the virtual tag and the coordinates of the line on the map in a database.

8. Virtual tagging device, adapted to execute a method according to claim 1.

9. Virtual tagging device according to claim 8, wherein the device is a handheld device.

10. Virtual tagging device according to claim 9, wherein the device is a mobile phone.

11. Computer program product, comprising instructions, that when executed on a virtual tagging device according to claim 8, implement a method according to claim 1.

12. Computer program product, comprising instructions, that when executed on a virtual tagging device according to claim 8, implement a method according to claim 7.
